(19) United States
(12) Patent Application Publication
(10) Pub. No.: US 2018/0254549 A1
(43) Pub. Date: Sep. 6, 2018

(54) WIRELESS ANTENNA MADE FROM BINDER-FREE CONDUCTIVE CARBON-BASED INKS

(71) Applicant: Chung-Ping LAI, Hsinchu County (TW)

(72) Inventor: Chung-Ping LAI, Hsinchu County (TW)

(21) Appl. No.: 15/966,267

(22) Filed: Apr. 30, 2018

Related U.S. Application Data
(63) Continuation-in-part of application No. 14/559,939, filed on Dec. 4, 2014.

(51) Int. Cl. H01Q 1/36; H01Q 1/38; H01Q 1/40; B41M 3/00; B41M 7/00

(52) U.S. Cl. CPC H01Q 1/368; H01Q 1/38; H01Q 1/2225; B41M 3/006; B41M 7/009; H01Q 1/40

(57) ABSTRACT

Binder-free conductive carbon-based ink is printed on flexible polymeric substrates such as PET and paper as an antenna for wireless devices. Without addition of polymer binder, conductivity of the carbon-based ink can be greatly improved. Owing to the enhance of conductivity, carbon-based ink proposed in this patent can be applied to antenna application, such as RFID, and enormously decreases the antenna cost. Further compression and protective coating will further enhance adhesion of antenna.

This application is a Continuation-in-Part of application Ser. No. 14/559,939, filed Dec. 4, 2014.

### BACKGROUND OF THE INVENTION

### Field of the Invention

This invention relates to a wireless antenna made from binder-free conductive carbon-based inks which remarkably enhances conductivity and enormously cuts down cost.

### DESCRIPTION OF THE PRIOR ART

In the patent literature, all conductive inks contain at least one kind of binders such as polymeric, epoxy, siloxane, rubber and resin based binders. Binders are insulator, so the amount of conductive material needs to be increased to maintain conductivity. Ink cost is then raised as well.

All conductive inks for antenna application consist of metals as the primary conductive materials. Usage of metals not only has disadvantage of high cost, but also causes limited lifetime from metal oxidation, complicated production process, and not flexible for some applications.

There are mainly two kinds of processes to produce antenna for wireless application. One is copper/aluminum foil etching. Such process involves complicated procedures, high-pollution chemicals like etchant, and corrosion-resistance substrates required. It is a high-cost process with high-pollution waste, and needs expensive equipment for photo-lithography process. Another is ink printing process including screen printing, inkjet printing, gravure printing, etc. Ink printing has the advantage of simple process, fast production, and low cost. However, its popularity is confined by inadequate performance of the conductive inks. Lack of both high conductivity and stability is the main issue for conductive inks on the market.

One key factor that defines the performance of antenna for wireless application is the transition efficiency between wave and current (radio frequency energy reception and conversion). Take RFID as an example, RFID consists of antenna and IC chip. Reader transmits electromagnetic waves to RFID labels. Antenna in RFID transfers electromagnetic waves into current to initiate the IC chips. Data stored in IC chips send back to reader through electromagnetic waves generated by antenna. Accordingly, transition efficiency of antenna plays a crucial role. To have good transition efficiency, antenna requires high conductivity and appropriate pattern design.

In a copper/aluminum etching method, antenna made by this process has the benefit of low resistance, high accuracy, and good performance. However, etching process is complicated and requires expensive equipment for photo-lithography. Therefore, high cost, long production time, and constrained substrate choices (like corrosion-resistance substrate) are the weakness of etching process, not to mention high-pollution chemicals like etchant and cleaner may cause environmental issues.

In an ink printing method, it is a fast and cheap process to direct print antenna patent onto substrates. Besides little pollution, there are plenty of applicable substrates due to this etching-free process. Nonetheless, antenna made by ink printing has secondary performances. Characteristics like flexibility, adhesion, and conductivity depend on the quality of conductive inks. High quality conductive inks often come with expensive prices, which offset the strength of ink printing method. So how to reduce the usual of metal powder and reduce the cost is one of key target.

By far, metal powders and metal coated powders are the primary conductive materials in conductive inks for application of antenna. Common-used metals are copper and silver. Silver has high price, while copper is easily oxidated. So copper powder coated by other novel metal is one of method to reduce the cost of ink.

Because the conductivity of metal powders is worse than that of bulk metal, there are several ways to improve the conductivity of conductive inks in both academy and industry. First, increase drying temperature so that metal particles realign themselves to reach better conductivity. In this case, substrates are limited to high-temperature resistance ones. Second, reduce the size of metal powders to nano level, so that metal particles can rearrange themselves at low temperature. However, nano-metals increase the cost as well.

Adhesion of metal powders is another issue. Metal powders cannot form a film onto substrate. Therefore, adhesion of metal powders relies on the addition of binders. Since binder is insulator, it affects the conductivity of ink as well. For conductive metal inks, it is hard to balance both adhesion and conductivity.

Some conductive inks claim to only use conductive carbon materials such as carbon black, graphite, carbon nanotube, graphene. The conductivity cannot compete with that of metal inks, because those carbon materials have lower conductivity. Moreover, binder additives are also implanted in such products.

US Pub. No. 20120277360 disclosed that conductive compositions consisted of graphene sheets and at least one polymeric binder to have good adhesion. Metals, alloys, and conductive metal oxides were optionally contained. The surface resistivity lied between 0.001 to 500 ohm/sq.

US Pub. No. 20040175515 disclosed that conductive particulate and/or flake materials can be printed to have sufficient conductivity for antenna by flexographic or gravure printing. Polymers or resins were also used at about 15˜25 wt % as binder. Conductive materials were metal oxide material, metal particles, and graphites. The sheet resistance was relatively high at 200 to 50000 ohm/sq.

U.S. Pat. No. 7,017,822 disclosed a conductive loaded resin-based material to form RFID antenna. The conductive materials included carbon, graphites, and metal powders like nickel, copper, and silver. Adhesion to substrates was reinforced by an epoxy adhesive, or direct molding onto resin-based materials. The sheet resistance was between 5 to 25 ohm/sq.

TW Pat. No. I434456 disclosed an inkjet printing method to produce RFID antenna. Metal ions such ad nickel, gold, and copper were dissolved in the ink, and were reduced back to metals by electroless-plating after drying. Such process is very complicated, and the substrate is confined to be non-woven slag fiber paper.

CN Pub. No. 101921505 also disclosed a conductive ink for RFID antenna. The conductive materials were composed of both nano-wires and nano-particles of silver. 2˜10% epoxy resin was used as binders.

CN Pub. No. 103436099 disclosed a composite conductive ink which includes both silver and graphene. However, silver and resin accounted for 20˜40%, and 5˜30% of the composition, respectively. That is, most composition still remained as silver and resin.

CN Pub. No. 103834235 disclosed a graphene conductive carbon ink. The conductive materials were graphene and other conductive carbons like graphite, carbon black, acetylene black, etc. Although no metals were used in this ink, the conductivity was not mentioned, nor was the antenna application declared. On the other hand, resin binders also accounted 0˜70% of the composition, which indicated a high portion of binder within the ink.

In order to increase the adhesion between conductive fillers and substrates, insulated polymer resin binders or mixtures were used in the various graphene-based conductive inks (see Table 1).

TABLE 1
The solid composition of various graphene-based conductive inks.

| | Solid composition | | | | |
|---|---|---|---|---|---|
| | | | resin | | |
| | | | binder or | | |
| | | Other | polymer | Dispersant | total |
| | graphene | fillers | mixture | & additive | solid |
| Patent # | (g) | (g) | (g) | (g) | (g) |
| CN 102964972B | 2.4 | 37.6 | 80 | 10.4 | 130.4 |
| | 1.8% | 28.8% | 61.3% | 8.0% | 100.0% |
| CN 103059636A | 10 | 60 | 25 | 36 | 131 |
| | 7.6% | 45.8% | 19.1% | 27.5% | 100.0% |
| CN 103214897B | 2.8 | 15 | 35 | 3 | 55.8 |
| | 5.0% | 26.9% | 62.7% | 5.4% | 100.0% |
| CN 103468101A | 10 | 15 | 80 | 30 | 135 |
| | 7.4% | 11.1% | 59.3% | 22.2% | 100.0% |
| CN103627223A | 7.1 | 5 | 125 | 5 | 142.1 |
| | 5.0% | 3.5% | 88.0% | 3.5% | 100.0% |
| CN 104109450A | 10 | 80 | 140 | 10 | 240 |
| | 4.2% | 33.3% | 58.3% | 4.2% | 100.0% |
| US | — | — | — | — | — |
| 2010/0000441 | 5.0% | 0.0% | 95.0% | 0.0% | 100.0% |
| A1 | | | | | |

### BRIEF SUMMARY OF THE DISCLOSURE

In this invention, we proposed that adhesion of binder-free conductive carbon-based ink comes from the good film-forming ability of carbon flakes. It is reported that well-dispersed graphene ink can form a free-standing graphene film simply by air-suction membrane filtering. Free-standing graphene films are robust and flexible. Such excellent film-forming ability is unique to carbon materials.

Since metal powders don't have film-forming ability, binder additives are unavoidable to attain good adhesion. Epoxy resin is one of the common binders. Besides its good stickiness to substrate, epoxy resin also has good film-forming ability, facilitating the linkage between metal powders. Other polymeric binders like rubber polymers also improve the adhesion of metal powders by their film-forming ability.

Accordingly, the pivotal notion in this invention is to use carbon flakes not only as the role of conductive fillers but also conductive binders simultaneously. The porous structure constructed by carbon flake can be changed to dense architecture by rolling compression. According to the structure change from porous to dense, carbon flake was proposed as conductive binder to catch other conductive fillers, such as metal particles or others carbon materials. Without addition of insulated binders in conductive inks, conductivity can be remarkably improved by rolling compression. However, resistance decrease by rolling compression cannot work for the binder-contained conductive ink. For example, the resistance of antenna printed by commercially conductive Ag-epoxy ink becomes higher (19%) after rolling compression. The resistance increase is attributed to the loosening of conductive fillers from binder mixture or the infiltrating of insulated binder into interspace between conductive particles after rolling. However, the effect of loosening of conductive fillers and infiltrating of insulated binder is not observed in the case of binder-free conductive ink. In order to exhibit the idea of conductive binder by using carbon flake materials, we used binder-free Ag/graphene conductive ink to print the antenna. After rolling, the Ag particles was trapped by the dense structure of carbon flake mixture. Without the influence of insulation binder, the resistance of antenna printed by binder-free Ag/graphene conductive ink is decreased for 50% after rolling. By this concept, cost of the conductive inks can be enormously cut down, and the benefits of ink printing can be fully realized.

TABLE 2
Comparison of compression effect between commercial conductive
Ag-epoxy ink and binder-free conductive ink in this invention.

| | Resistance | | |
|---|---|---|---|
| | between two sides of antenna | | |
| | (Ohm) | | |
| | Before | After | Change |
| Item | compression | compression | rate |
| Commercially | 2.1 | 2.5 | +19% |
| conductive | | | |
| Ag-epoxy ink | | | |
| Binder-free | 1.8 | 0.9 | −50% |
| conductive ink | | | |

In a first aspect of the present invention, there is provided a method of making wireless antenna from binder-free conductive carbon-based inks containing steps of:

printing conductive carbon-based inks onto a flexible substrate which has capillary pores and percolating solutions into the capillary pores of the flexible substrate, wherein the conductive carbon-based inks includes conductive materials accounting for 90˜99.9999 wt % of a total solid content, and the conductive materials have conductive carbon flakes (like graphene or graphite nanoflakes) and other conductive fillers such as metal particles or other carbon materials, hence a coating film is formed together with the flexible substrate, and a co-filming area is formed at an interface between the printed conductive layer and the flexible substrate; the conductive carbon-based inks also includes at least one dispersant added at 0.0001˜10 wt % of the total solid content; the conductive carbon-based inks also includes solvent possessing at least one carrier;

thermal drying the conductive carbon inks to form a wireless antenna;

compressing the wireless antenna to close the pore structure and raise a density of a carbon-based conductive line of the wireless antenna, wherein a compression ratio is 50˜99% of an originally total thickness of substrate and printed antenna pattern;

optionally implanting a protective layer on a top of the wireless antenna.

### BRIEF DESCRIPTION OF THE DRAWINGS

Embodiments of the invention are further described hereinafter with reference to the accompanying drawings, in which:

FIG. 1A is SEM image of the fibers in paper according to a preferred embodiment of the present invention.

FIG. 1B is an illustrative schematic showing the cross section of antenna on a paper, wherein conductive ink is printed on the paper according to the preferred embodiment of the present invention.

FIG. 1C is an illustrative schematic showing the co-filming area at the interface between printed conductive layer and papers according to the preferred embodiment of the present invention.

FIG. 2 is an illustrative schematic of antenna with spiral pattern according to the preferred embodiment of the present invention.

FIG. 3A is an illustrative schematic showing a main antenna being printed on a substrate according to the preferred embodiment of the present invention.

FIG. 3B is an illustrative schematic showing an insulation layer being put on a surface of the main antenna according to the preferred embodiment of the present invention.

FIG. 3C is an illustrative schematic showing a connect line of antenna being printed according to the preferred embodiment of the present invention.

FIG. 4 is return loss behaviour of different antenna patterns being printed with the binder-free conductive carbon-based inks according to the preferred embodiment of the present invention.

FIG. 5 is an image from optical microscope showing the precision of an antenna being printed with binder-free conductive carbon-based ink according to the preferred embodiment of the present invention.

FIG. 6 is a picture showing the appearance of antenna printed with binder-free conductive carbon-based ink according to the preferred embodiment of the present invention.

FIG. 7 is a picture showing easy destruction of the antenna by simply ripping it according to the preferred embodiment of the present invention.

FIG. 8 shows a list of a readability test carried out by a wireless signal reader, wherein two types of antenna are printed according to the preferred embodiment of the present invention.

### DETAILED DESCRIPTION

Binder-free conductive carbon-based inks according to a preferred embodiment of the present invention can be printed onto flexible substrates like papers or polymeric films, such as PET. It is preferred to have capillary pores within substrates. As inks are printed onto substrates, solutions percolate into the pores of the substrates. Taking advantage of its excellent film-forming ability, carbon flakes (like graphene or graphite nanoflake) can form a film together with substrates. Adhesion can be further enhanced by compression, which induces Van der Wall force adhesion of carbon flake to substrate. On the other hand, when other conductive fillers such as metal particles or other carbon materials are in the binder-free carbon flake ink, such conductive fillers would also trapped by dense carbon flake layer after rolling compression. So a low resistance and good adhesion binder-free conductive ink is disclosed. Based on this concept, the correlation between pore sizes of substrates, and the flake size and shape of carbon powders has decisive effects on adhesion.

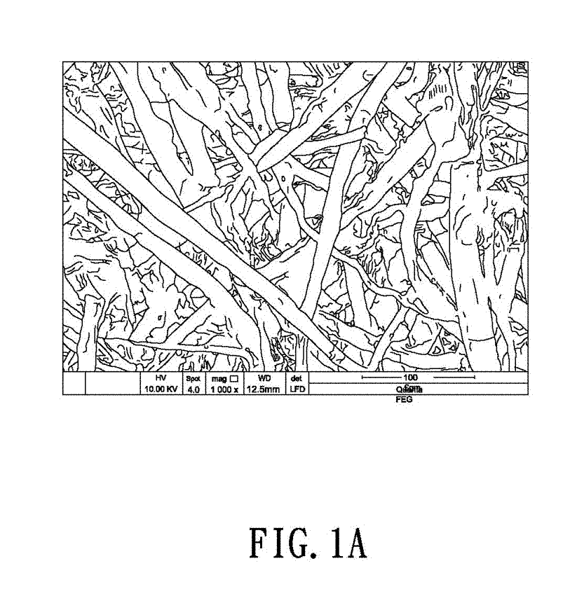

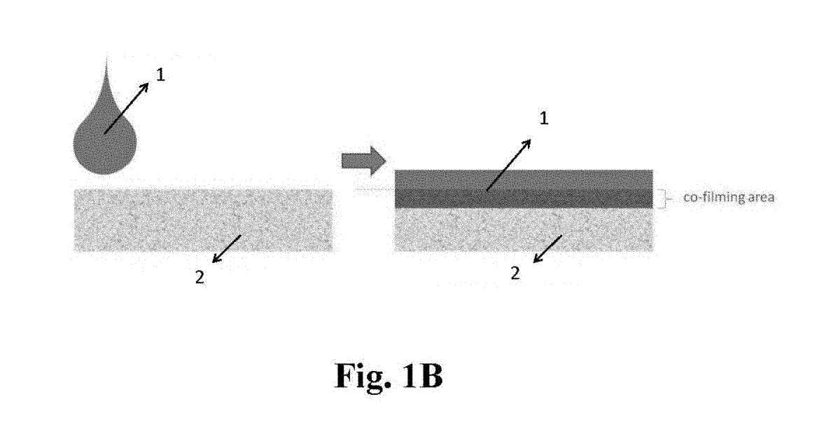

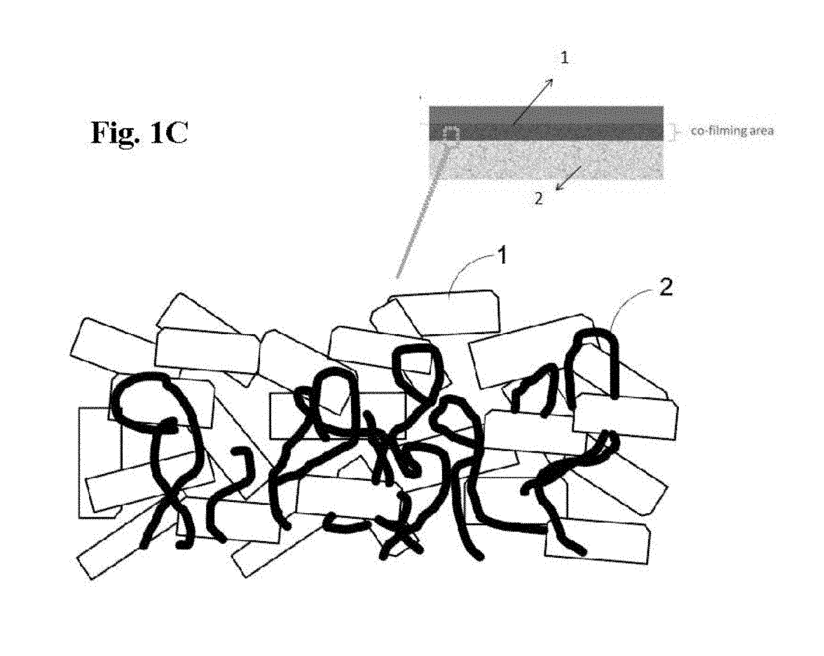

Taking paper for examples, a co-filming between printed conductive layer and substrates can be found. SEM image of the fibres in paper is shown in FIG. 1A. FIG. 1B is a cross sectional view showing antenna on a paper, wherein conductive ink 1 is printed on the paper 2. With reference to FIG. 1C, a co-filming area is formed at an interface between printed conductive layer and papers.

Ink will be absorbed/and soaked into the capillary pores of the porous flexible substrate when substrate has porous capillary pores. So a co-filming area is formed at the surface of the substrate. As showed in FIG. 1C, the instruction of the flake materials of the conductive component into the substrate materials builds a strong connection at the interface between the carbon powders and the flexible substrate.

Without any insulating binder additives, conductive carbon-based ink in this patent can reach very low resistance after rolling compression. In this regard, resistance is relative to coating thickness, size and shape of fillers, and density of the coating film. In general, resistance can be decreased by increasing the coating thickness, raising the density of coating film, and choosing carbon powders with larger diameter and thickness.

The thickness of wireless antenna will be further reduced after the treatment of compression rolling. A compression ratio means the thickness of antenna before rolling compression over that after rolling compression. Preferably, the thickness of the conductive layer is compressed to 50% to 99% of the original thickness. And the conductive layer can be compressed with heating, wherein the temperature ranged from 60° C. to 200° C.

Owing to the strong compressive force and temperature involved in the compressing process, the Van Der Waal force of the flake materials in the solid can be increased and generate strong adhesion for the formation of film and adhesion on the substrate.

Accordingly, sheet resistance of this conductive carbon-based inks is at a range from 0.1˜2000 ohm/sq (corresponding resistivity 1×10⁻⁶˜8×10⁻³ ohm-m). For the application of wireless antenna, sheet resistance from 0.1˜50 ohm/sq (corresponding resistivity 1×10⁻⁶˜2.5×10⁻⁴ ohm-m) is preferred.

The primary conductive binder in this invention are conductive carbon flakes with graphite structure. At least one kind of the carbon flake powders including graphene, graphite nanoflake, and flake-shaped carbon black (Ex: KS6), is used. The thickness of carbon powders ranges from 1˜10000 nm, and the grain size is from 0.1˜100 μm. Conductive materials, including of carbon flakes and other conductive fillers, account for 90˜99.9999 wt % of the total solid content in this ink.

Dispersant is also contained in this conductive ink. It can be either non-ionic dispersant such as P-123, Tween 20, Xanthan gum, Carboxymethyl Cellulose (CMC), Triton X-100, Polyvinylpyrrolidone (PVP), Brji 30, or ionic dispersant like Poly(sodium 4-styrenesulfonate) (PSS), 3-[(3-Cholamidopropyl)dimethyl ammonio]-1-propanesufonate (CHAPS), Hexadecyltrimethylammonium bromide (HTAB), Sodium taurodeoxycholate hydrate (SDS), 1-Pyrenebutyric acid (PBA), and so on. At least one of the dispersants is added at 0.0001˜10 wt % of the total solid content.

Solvent of the conductive inks can possess one or more carriers. Carriers can be aqueous, organic, or inorganic. Examples of suitable carriers include Methyl-2-pyrrolidone (NMP), IPA (Isopropyl alcohol), ethanol, glycerol, ethylene glycol, butanol, propanol, propylene glycol monomethyl ether (PGME), propylene glycol monomethyl ether acetate (PGMEA), and so on.

Total solid content of the binder-free conductive carbon-based ink ranges from 2 to 85 wt % of the total weight of ink.

Ink printing processes including screen printing, inkjet printing, gravure printing, flexographic printing, etc, are utilized to produce wireless antenna from our binder-free conductive carbon-based inks. In the case of screen printing, screen grids are from 100 to 400 mesh. For inkjet printing, the printing precision is up to mechanical positioning. The best one can reach 0.1 μm level today.

Flexible substrates can be conventional paper, wood, porous glass, porous polymer, porous metal, porous ceramics, textile materials, and their derived composites. In the case of papers, basis weight of papers ranges from 10˜500 g/m²; density of papers is between 0.5˜2.5 g/cm³, average pore sizes is within 0.02˜500 μm.

Thermal drying is the main drying method of the conductive ink. Heating temperature can be within 30˜300° C., and the drying time is 5 min˜30 min. The higher the temperature, the faster the drying. Preferably, the temperature of thermal drying ranges from 60° C. to 200° C. After drying, antenna is further compressed to raise the density of the carbon conductive line of the wireless antenna. Compression ratio is 50 to 99% of the originally total thickness of the antenna pattern and substrate.

A protective layer of polishing/lamination was optionally implanted on a top of the antenna for certain antenna design to enhance the performance. Polishing materials can be Polyester (PET), Polypropylene (PP), Polyvinyl alcohol (PVA), varnish, Oriented polypropylene (OPP), Polyvinylchloride (PVC), etc.

Antenna made from this binder-free conductive carbon-based ink can be applied to wireless application including high frequency (typically 13.56 MHz), ultra high frequency (800˜1000 MHz), microwave (2˜5 GHz), and even higher frequency such as 50 GHz.

In application, as shown in FIG. 2, antenna with spiral pattern for such high frequency or chipless RFID needs two conductive layers separated by an insulating layer. A multi-stepped printing strategy is used to prepare 3D antenna and includes steps of:

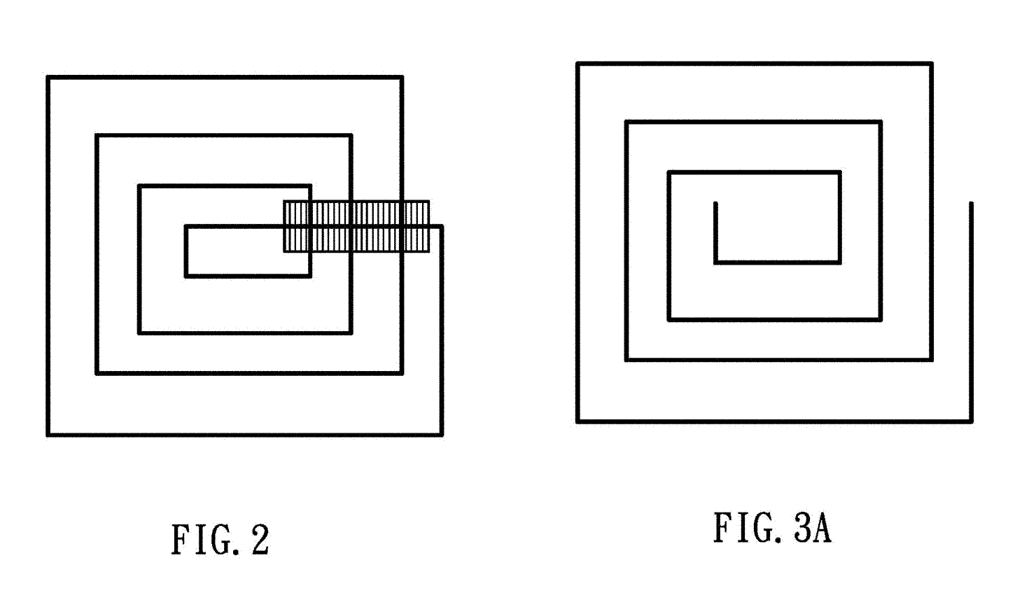

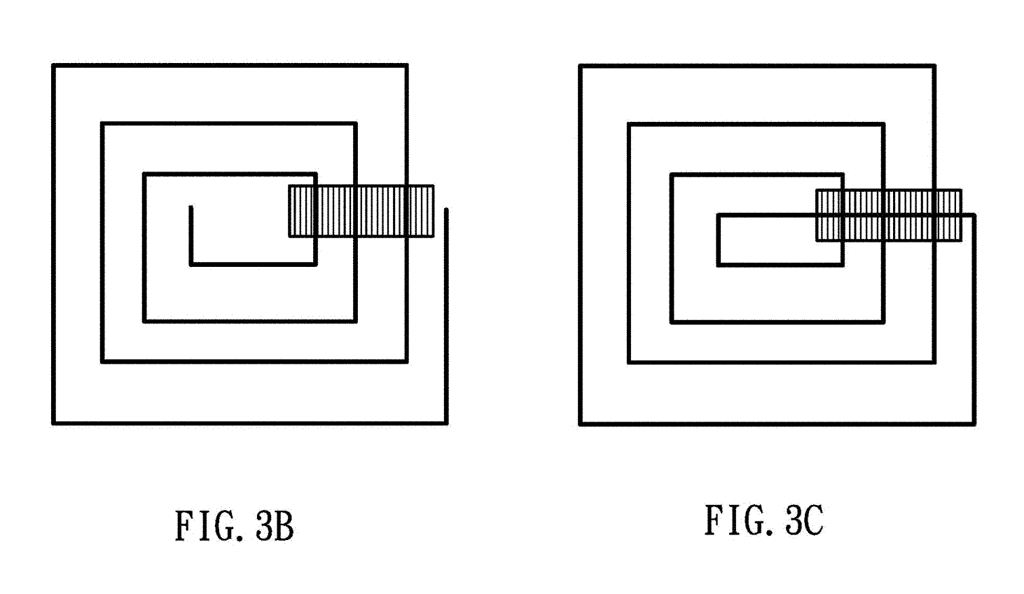

A). printing a main body of the antenna on a substrate, as shown in FIG. 3A;

B). printing an insulation layer on a surface of the main body of the antenna, as illustrated in FIG. 3B;

C). printing a connect line of antenna, as shown in FIG. 3C.

Preferably, a screen-printing or multi-channel inkjet printer can be used in this process.

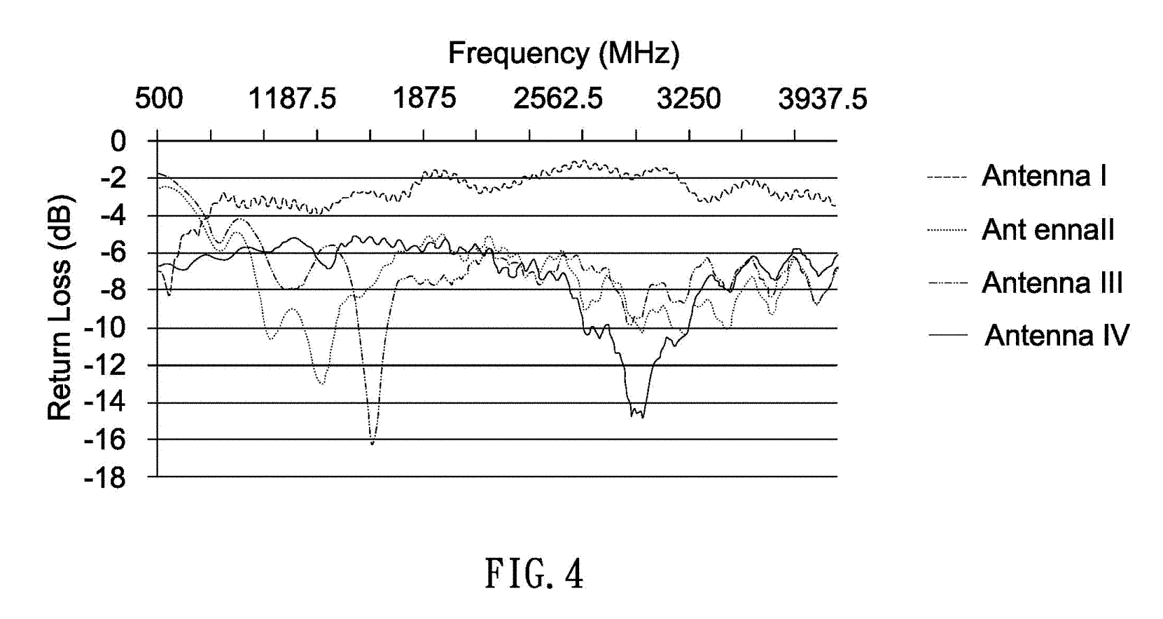

Referring to FIG. 4, different antenna patterns were printed with our binder-free conductive carbon-based inks. Return loss behavior was measured as shown in figure. It is clearly illustrated that signals at different frequency range correspond to specific antenna patterns. In this exhibition, significant signals can be found in both UHF and microwave frequency for wireless antenna application.

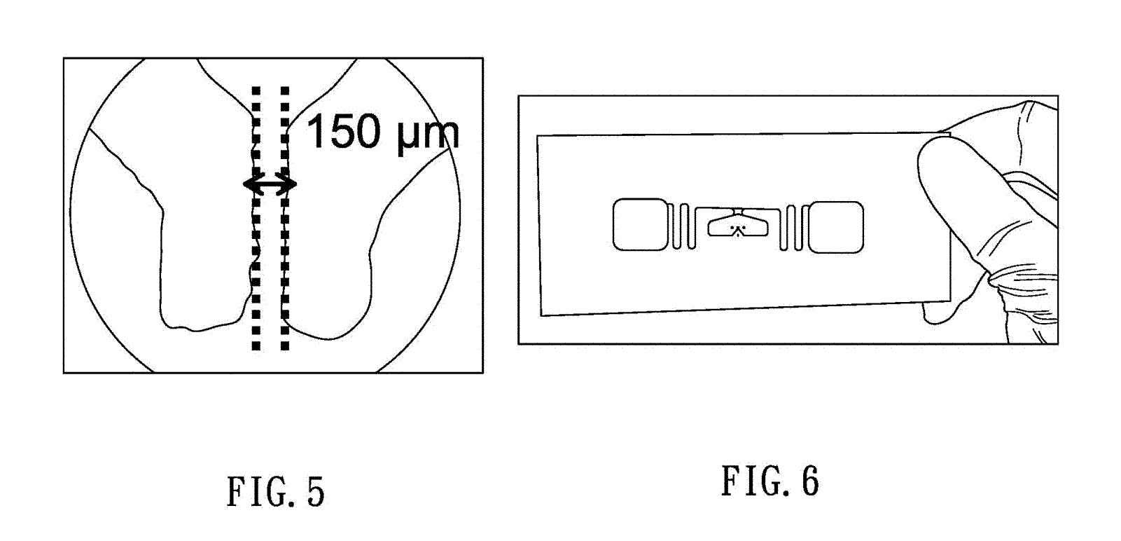

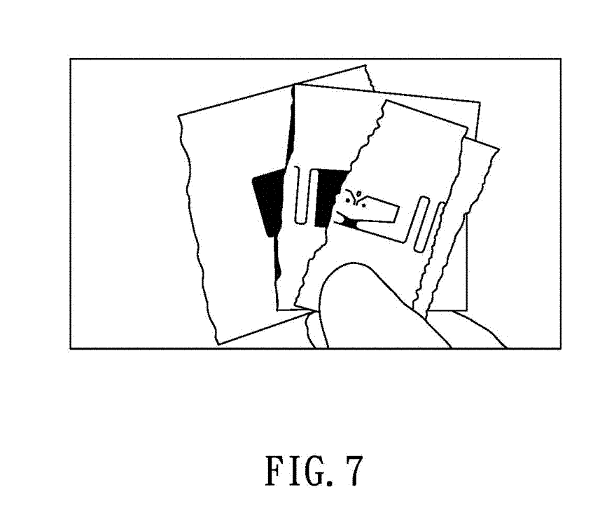

FIGS. 5 and 6 show the antenna printed with the binder-free conductive carbon-based ink of the present invention. Thereby, there is no difference in the appearance, compared with aluminum-etched antenna. The printing precision especially in the chip-bonding area can be as high as 150 μm without any short circuit. Direct printing on papers remarkably simplifies the production process that once involved metal etching or antenna transmission. Also, as illustrated in FIG. 7, easy destruction of the antenna by simply ripping it is one of the unique characteristics, resulting from versatile substrates and low-cost process.

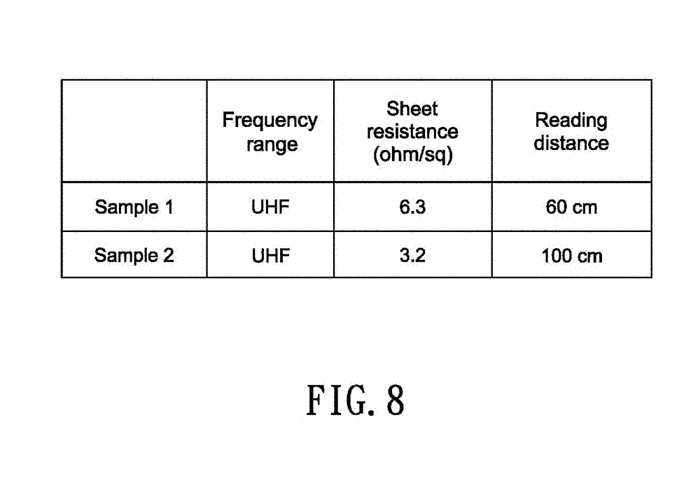

Preferably, IC chips are bonded onto antennas made with binder-free conductive carbon-based ink. Referring to FIG. 8, a readability test is carried out by a wireless signal reader. Two types of antenna were printed. One is a straight-line pattern, and the other is a meandered-line pattern. Sheet resistance of the antenna is shown in the table. It is exhibited that both types of antenna are readable. Accordingly, antenna printed with binder-free conductive carbon-based ink is applicable in wireless application.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A method of making wireless antenna from binder-free conductive carbon-based inks comprising steps of:
(1) printing binder-free conductive carbon-based inks on a substrate;
(2) thermal drying the conductive carbon-based inks to form a conductive layer;
(3) compressing the conductive layer.

2. The method of making the wireless antenna as claimed in claim 1, wherein the substrate is porous and flexible.

3. The method of making the wireless antenna as claimed in claim 2, wherein the substrate has capillary pores.

4. The method of making the wireless antenna as claimed in claim 2, wherein the substrate is any one of paper, wood, porous glass, porous polymer, porous metal, porous ceramics, textile materials, and their derived composites.

5. The method of making the wireless antenna as claimed in claim 1, wherein a temperature of the thermal drying ranges from 60° C. to 200° C. and a drying time is 5 min to 30 min.

6. The method of making the wireless antenna as claimed in claim 1, wherein a thickness of the conductive layer is compressed to 50% to 99% of an original thickness.

7. The method of making the wireless antenna as claimed in claim 1, wherein the conductive layer is compressed with heating, wherein a temperature ranges from 60° C. to 200° C.

8. The method of making the wireless antenna as claimed in claim 1, wherein the wireless antenna is a three dimensional (3D) antenna and includes a main body printed on the substrate, an insulation layer printed on a surface of the main body of the wireless antenna, and a carbon conductive line printed in the wireless antenna.
